(19) United States
(12) Patent Application Publication
(10) Pub. No.: US 2026/0034807 A1
(43) Pub. Date: Feb. 5, 2026

(54) Media Processing Device with Media Processing Error Detection and Associated Methods

(71) Applicant: ZEBRA TECHNOLOGIES CORPORATION, Lincolnshire, IL (US)

(72) Inventors: Edward C. Thomas, Gurnee, IL (US); Daniel P. Lanigan, Elgin, IL (US); David S. Schmitt, Bolingbrook, IL (US); Morgan Hassan Malone, Swansea, MA (US)

(21) Appl. No.: 18/789,544

(22) Filed: Jul. 30, 2024

(51) Int. Cl. B41J 11/00; B41J 2/335; B41J 3/407; B41J 11/04; B41J 11/14; B41J 11/70; B41J 15/02; B41J 15/04; B41J 29/46

(52) U.S. Cl. CPC B41J 11/0095; B41J 2/335; B41J 3/4075; B41J 11/006; B41J 11/04; B41J 11/14; B41J 11/70; B41J 15/02; B41J 15/04; B41J 29/46

(57) ABSTRACT

A media processing device includes a platen roller, a printhead, a media exit, a first sensor disposed proximate to the platen roller, a second sensor disposed proximate to the media exit, and a logic circuit. The printhead is configured to form a nip with the platen roller. The logic circuit is operatively coupled to the first and second sensors and is configured to discriminate between a normal operation of the media processing device, a media jam error, and a media wrap error based on outputs from the first and second sensors.

### BACKGROUND

Linerless labels were developed to reduce the quantity of waste produced during label printing using convention liner-based labels. Linerless labels are those labels that are printed and used without conventional release layers or liners. Liners are typically used to support pressure sensitive adhesive labels as they move through a printer. Liners protect the adhesive surface of the label from environmental contaminants and also reduce the incidence of printer binding or jamming.

One challenge of using linerless labels is that the exposed adhesive surface of the linerless label media can undesirably adhere or stick to components of the printer, thereby complicating the operation of the printer. For example, the adhesive surface of the linerless label media can adhere and can become wrapped around the platen roller of the printer, thereby jamming (and possibly damaging) the platen roller and/or other components of the printer. Adhesion of the linerless label media to the platen roller can result from normal use and/or can be exacerbated by certain operating conditions, such as extreme temperatures, high humidity, other environmental conditions, adhesive deposits, prolonged pauses in operation, and the like.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example media processing device in accordance with embodiments of the present disclosure.

FIG. 2 illustrates the example media processing device of FIG. 1 with an access door assembly in an open position in accordance with embodiments of the present disclosure.

FIG. 3 illustrates a side profile of an internal cavity of the example media processing device of FIG. 1 in accordance with embodiments of the present disclosure.

FIG. 4 illustrates a side profile of area A in FIG. 2 cross sectioned along the plane B in accordance with embodiments of the present disclosure.

FIG. 5 is a block diagram illustrating an example operation of an embodiment of a media processing device without a media handling error in accordance with the present disclosure.

FIG. 6 is a block diagram illustrating an example operation of an embodiment of a media processing device with a first type of media handling error in accordance with the present disclosure.

FIG. 7 is a block diagram illustrating an example operation of an embodiment of a media processing device with a second type of media handling error in accordance with the present disclosure.

FIG. 8A is a block diagram of another example media processing device in accordance with embodiments of the present disclosure.

FIG. 8B is a block diagram of yet another example media processing device in accordance with embodiments of the present disclosure.

FIG. 9 is a flowchart illustrating an example process in accordance with embodiments of the present disclosure.

FIG. 10 is a flowchart illustrating an example process in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of printers and media processing devices of the present disclosure can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process. As an example, embodiments of printers and media processing devices of the present disclosure may be configured to print and/or encode media drawn from a media source, such as roll, spool, or fanfold. Such media may include a continuous web such as a spool of linerless media. The continuous web of linerless media is coated on one surface with a pressure sensitive adhesive and includes a printable surface on the opposite surface. For thermal transfer printing, the printable surface of the linerless media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

The web of linerless media is routed along a feed path from the media supply to a print position located adjacent to the printhead (e.g., a thermal printhead). The continuous web of linerless media is pulled through the feed path by a driven platen roller. The platen roller is designed to contact the adhesive surface of the linerless media as it pulls the linerless media through the feed path. The printhead is generally configured to form a nip with the platen roller to pinch the linerless media between the printhead and the platen roller. This pinching or compressive force provides adequate print quality, and in some applications, ensures that a sufficient tension is maintained along the continuous web of linerless media. Once printed, the printed portion of the linerless label media is advanced outwardly from the printer through a media outlet by the platen roller where it can be cut and/or torn to separate the printed label from the media supply.

As the media is fed past the platen roller, different types of media handling errors can occur. As an example, the media may jam as it is fed through or passed one or more components causing the media to buckle and/or crease. One reason the media may jam is because the leading edge of the media may curl causing it to deviate from a specified feed path. As another example, the adhesive of the linerless media can cause the linerless media to adhere to the platen roller as the platen roller rotates. As a result, the media can adhere to and/or wrap around the platen roller. Removal of the media wrap on the platen roller can be difficult because access to the platen roller in situ is limited due to operational and structure constraints of the printer. For example, the components of the printers are typically positioned close together within an internal cavity of a housing having limited space. For instance, the media outlet or exit is generally too narrow for a user to access the platen roller through the media exit, and when a door assembly of the printer is in the open position to expose an internal cavity, a printhead assembly and/or cutting assembly can be positioned in a manner that makes it difficult to reach the platen roller and remove the wrapped media from the platen roller. For example, in an engaged position, the printhead is positioned adjacent to platen roller typically leaving just enough space for the thickness of the media to pass through. In a disengaged position, the printhead can be move away from the platen roller. However, the movement of the printhead assembly is also limited such that there is typically less than about one inch between the printhead and the platen roller. As another example, the cutting assembly can be positioned between the platen roller and the media exit and can further impede access to the platen roller. As another example, the non-driven or distal end of the platen roller is typically retained within a frame, and in some instances, only extends a small distance (e.g., less than one hundredth of an inch) such that manipulation of the distal end of the platen roller is typically not possible or practical.

In accordance with embodiments of the present disclosure, a media processing device is disclosed. The media processing device includes a platen roller, a printhead, a media exit, a first sensor, a second sensor, and a logic circuit. The printhead is configured to form a nip with the platen roller. The first sensor is disposed proximate to the platen roller. The second sensor is disposed proximate to the media exit. The logic circuit is operatively coupled to the first and second sensors. The logic circuit is configured to discriminate between a normal operation of the media processing device, a media jam error, and a media wrap error based on outputs from the first and second sensors.

In accordance with embodiments of the present disclosure, the first sensor is configured to sense a state of the platen roller and the second sensor is configured to sense the presence or absence of media proximate to the media exit.

In accordance with embodiments of the present disclosure, the media processing device includes a motor operatively coupled to the platen roller. The logic circuit is configured to cease driving the motor in response to detecting a media jam error or media wrap error.

In accordance with embodiments of the present disclosure, the media processing device includes a motor operatively coupled to the platen roller. The logic circuit is configured to drive the motor to rotate the platen roller in a first direction to facilitate a printing process and to drive the motor to rotate the platen roller in a second direction in response to detecting a media jam error or media wrap error. In accordance with embodiments of the present disclosure, the logic circuit drives the motor to rotate the platen roller in the second direction.

In accordance with embodiments of the present disclosure, the media processing device includes an output device operatively coupled to the logic circuit. The logic circuit is configured to output an indication via the output device in response to the logic circuit determining that the media jam error or the media wrap error has occurred. In accordance with embodiments of the present disclosure, the logic circuit is configured to output a first indication when the logic circuit determines that the media jam error has occurred and to output a second message when the logic circuit determines that the media wrap error has occurred.

In accordance with embodiments of the present disclosure, the printhead defines a print line that is radially disposed relative to the platen roller in first plane and the first sensor radially disposed relative to the platen roller in a second plane, the second plane having a nonzero angle relative to a first plane. In accordance with embodiments, the non-zero angle is forty-five degrees, ninety degrees, one hundred eighty degrees, is greater than zero and less than ninety degrees, is greater than or equal to forty-five degrees and less than one-hundred thirty-five degrees.

In accordance with embodiments of the present disclosure, the first sensor is offset from a print line by a nonzero angle circumferentially relative to a surface of the platen roller and oriented to sense a surface of the platen roller as the platen roller rotates. The first sensor is configured to provide a first output that is indicative of whether media has adhered to the surface of the platen roller after passing the print line.

In accordance with embodiments of the present disclosure, the first sensor is a reflective optical sensor and the second sensor is a transmissive optical sensor.

In accordance with embodiments of the present disclosure, the media processing device includes a media scraper disposed between the platen roller and the media exit. The media scraper is configured to guide media off of the platen roller and towards the media exit. The first sensor is disposed under the media scraper.

In accordance with embodiments of the present disclosure, the media processing device include a cutting assembly disposed between the platen roller and the media exit. The second sensor is disposed between a cutting blade of the cutting assembly and the media exit.

In accordance with embodiments of the present disclosure, the logic circuit is configured to determine that the media wrap error has occurred based on an output of the first sensor indicating the presence of media.

In accordance with embodiments of the present disclosure, the logic circuit is configured to determine that the media jam error has occurred based on the logic circuit expecting media to be present at the media exit, the output of the first sensor indicates the media is absent, and the output of the second sensor indicates the media is absent.

In accordance with embodiments of the present disclosure, the media processing device includes a media supply spindle or a further roller and a motor operatively coupled to the media supply spindle of the further roller. The logic circuit is configured to drive the motor to rotate the media supply spindle or the further roller in a first direction to facilitate a printing process and to drive the motor to rotate the media supply spindle or the further roller in a second direction in response to detecting a media jam error or media wrap error.

In accordance with embodiments of the present disclosure a method is disclosed. The method includes positioning a first sensor proximate to the platen roller of a media processing device. The first sensor is offset from a print line by a nonzero angle circumferentially relative to a surface of the platen roller and oriented to sense a surface of the platen roller as the platen roller rotates. The first sensor is configured to provide a first output that is indicative of whether media has adhered to the surface of the platen roller after passing the print line. The method further includes positioning a second sensor disposed proximate to the media exit. The second sensor is configured to provide a second output that is indicative of whether the media is present at the media exit. The method further includes operatively coupling the first and second sensors to a logic circuit. The logic circuit being configured to execute code stored in memory to discriminate between a normal operation of the media processing device, a media jam error, and a media wrap error based on first and second outputs from the first and second sensors. In accordance with embodiments of the present disclosure, a non-transitory computer readable medium storing instructions is disclosed, wherein execution of the instructions by a logic circuit causes the logic circuit to perform the method.

In accordance with embodiments of the present disclosure, the method also includes driving a platen roller to advance media along a feed path past a printhead and towards a media exit of a media processing device; sensing, via a first sensor disposed proximate to the platen roller, whether the media is present or absent; sensing, via the second sensor disposed proximate to the media exit, whether the media is present or absent; and discriminating, by a logic circuit, between a normal operation of the media processing device, a media jam error, and a media wrap error based on outputs from the first and second sensors.

In accordance with embodiments of the present disclosure, the method also includes ceasing to drive the platen roller in response to detecting a media jam error or media wrap error.

In accordance with embodiments of the present disclosure, driving a platen roller to advance media along a feed path comprises driving the platen roller to rotate in a first direction; and the method further comprises driving the platen roller to rotate in a second direction in response to detecting a media jam error or media wrap error.

In accordance with embodiments of the present disclosure, the method also includes outputting an indication via an output device in response to the logic circuit determining that the media jam error or the media wrap error has occurred. In accordance with embodiments of the present disclosure, outputting an indication via an output device comprises outputting a first indication when the logic circuit determines that the media jam error has occurred and outputting a second message when the logic circuit determines that the media wrap error has occurred.

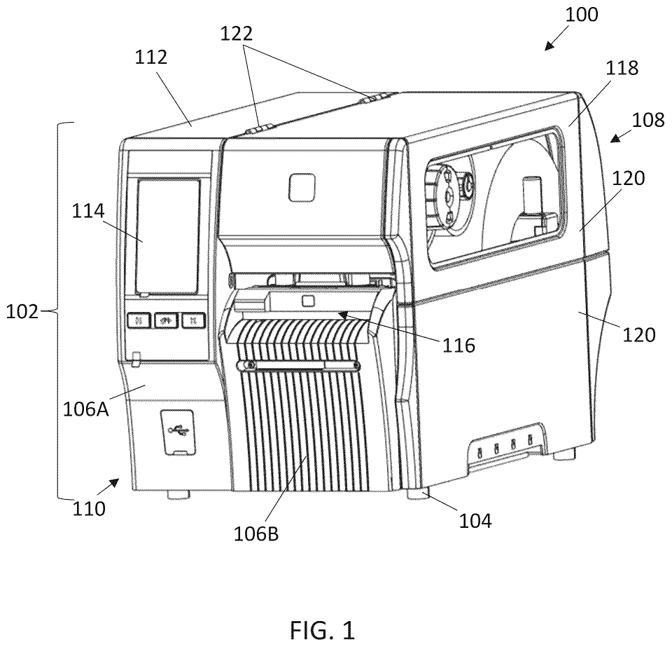

FIGS. 1-3 illustrate an example of media processing device 100, such as a printer, in accordance with embodiments of the present disclosure. The media processing device 100 can include a housing 102 and a base 104. The housing 102 may include a front panel 106A, a cutting assembly panel 106B (which together with the front panel 106a can form a front portion of the housing 102), a rear panel 108, a side panel 110, a support surface 112, and an access door assembly or cover assembly 118. The housing 102 may include a user interface 114 and a media outlet or exit 116. The media exit 116 may be arranged in the cutting assembly panel 106B of the media processing device 100 and may be configured to expel media through a slot after it has been processed. The access door assembly 118 includes one or more doors 120 and can be hingedly attached to the support surface 112 with hinges 122. The access door assembly 118 is illustrated in the closed or operational position in FIG. 1, in which access to the internal components of the media processing device 100 is precluded. In addition to keeping dirt, dust, and foreign objects from entering an internal cavity of the media processing device 100 and potentially contaminating the consumables or the electronics of the processing device 100, the closed position of the access door assembly 118 may also reduce noise and prevent users from inadvertently touching sensitive components.

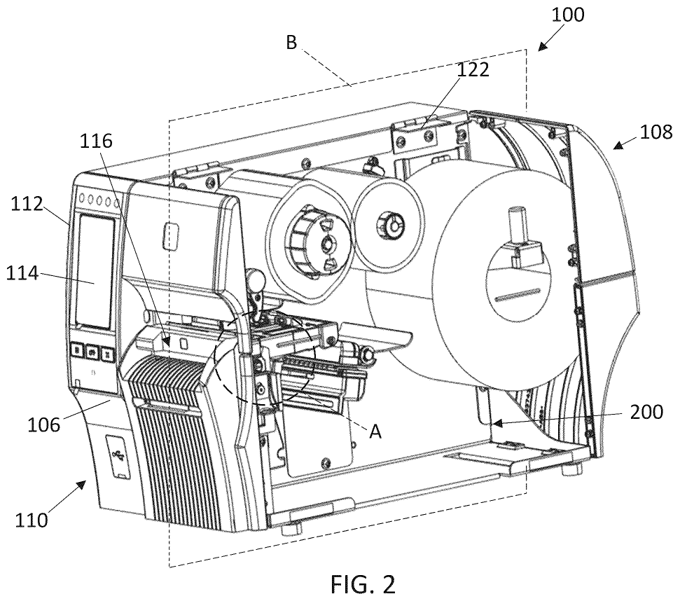

The access door assembly 118 may pivot about hinges 122 through a range of approximately 180 degrees to a major support position to provide access to an interior cavity 200 of the media processing device 100 in an open or non-operational position as illustrated in FIG. 2. The hinges 122 may be located proximate a centerline of the housing 102 defined between the support surface 112 and the access door assembly 118. Positioning the hinges 122 proximate a centerline of the housing 102 allows the access door assembly 118 to pivot about hinges 122 and achieve the support position when the access door assembly 118 comes to rest on the support surface 112. In some embodiments, the access door assembly 118 may include at least a portion of the front panel 106 and/or a portion of the rear panel 108 to provide greater access to the interior cavity 200 when the access door assembly 118 is positioned in the open position. Operation of the media processing device 100 may be precluded when the access door assembly 118 is in the open position.

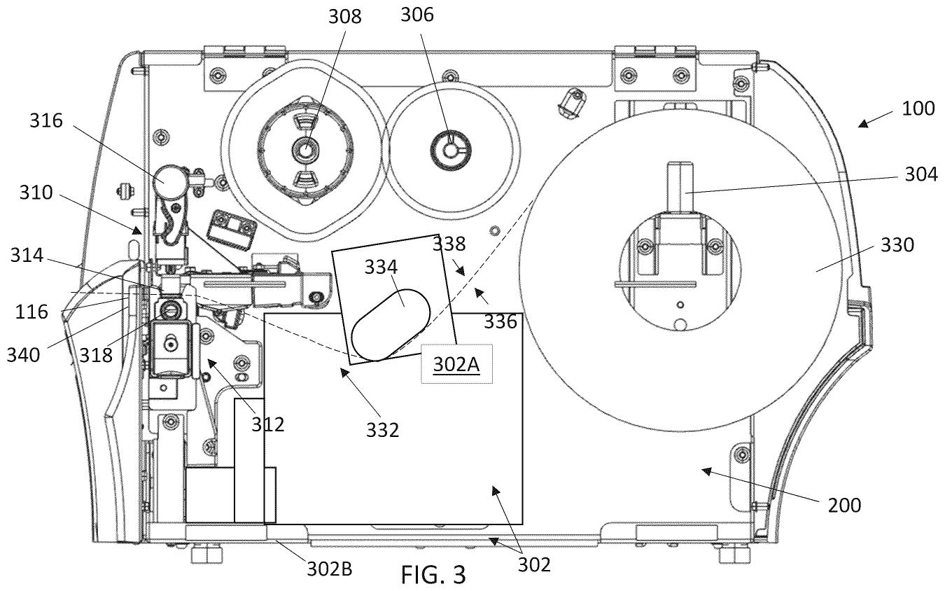

As shown in FIGS. 2-3, with the access door assembly 118 omitted to show an interior of the media processing device 100, components for loading and unloading consumables (e.g., print media and printer ribbon) within internal cavity 200 can be accessible and components associated with processing media along a feed path can be viewed.

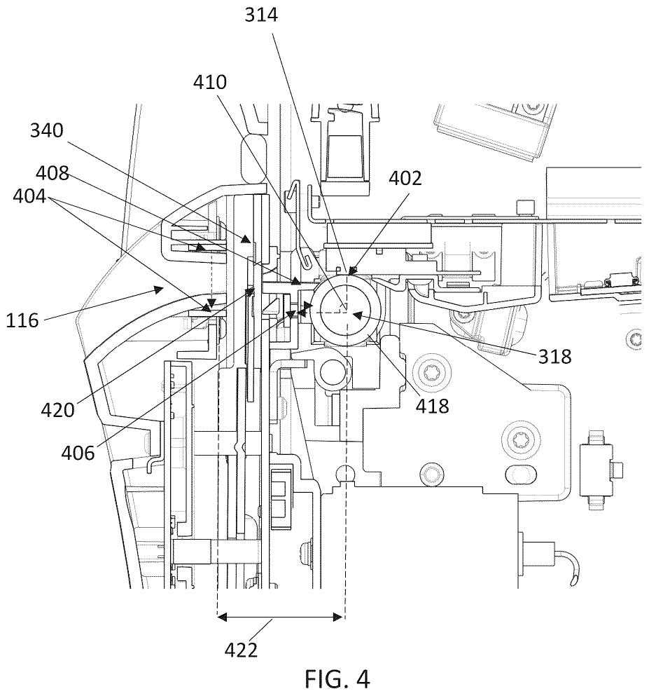

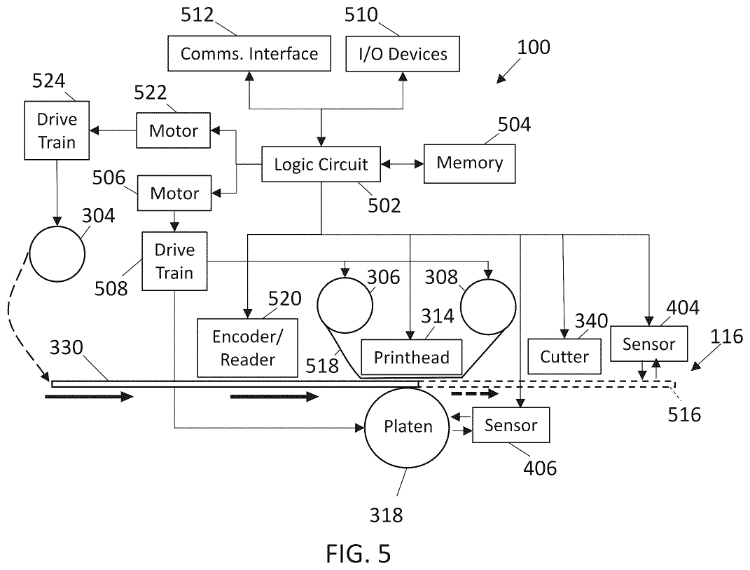

FIG. 3 illustrates a side view of the media processing device 100 with the access door assembly omitted for showing the internal cavity 200 and a frame 302 that supports at least some of the components for processing media 330 along a feed path 332. The frame 302 can include a chassis 302A and a base 302B. FIG. 4 illustrates a more detailed view of the area A in FIG. 2 along a cross-section defined by the plane B in FIG. 2 to show some of the components within the internal cavity 200. Referring to FIGS. 2-7, the frame 302 is a structural member configured to support at least some of the internal components in the internal cavity 200. The electronics and drive components (e.g., a logic circuit 502, a non-transitory computer-readable medium such as memory 504, a motor 506, a drive train 508, input/output devices 510, and/or communications interface 512, a motor 522, a drive train 524 as shown in FIG. 5) of the media processing device 100 can be in a cavity on the other side of frame 302 that is generally inaccessible to the user without taking the media processing device 100 apart. The electronics and drive components can control an operation of at least some of the internal components within the internal cavity 200. The internal components within the internal cavity 200 can include a media supply hanger or spindle 304, a ribbon supply spindle 306, a ribbon take up spindle 308, a printhead assembly 310 (and/or printhead 314), and a platen assembly 312 (and/or platen roller 318). The media spindle 304 can hold a media spool or media roll (e.g., media 330). In some embodiments, the media spindle 304 can be fixed and the media spool or roll can rotate about the media spindle 304. In some embodiments, the media spool or media can be locked to the media spindle 304 and the media spindle can be driven to rotate (e.g., via a motor 522 and drive train 524 shown in FIGS. 5-7) and the media spool or media roll can rotate in unison with the media spindle 304. For embodiments that utilize an ink ribbon (e.g., thermal transfer embodiments, the ribbon supply spindle 306 can hold a spool of an unused portion of a ribbon while the ribbon take-up spindle 308 can hold a spool of a used portion of the ribbon. While an embodiment of the media processing device 100 has been illustrated to include ribbon supply and take-up spindles 304 and 306, respectively, embodiments of the media processing device 100 may not include ribbon supply and take-up spindles 304 and 306, e.g., for embodiments of the media processing device 100 that do not require a ribbon to print on media 330 (e.g., embodiments implemented via direct thermal printing). The printhead assembly 310 can include a printhead 314 (e.g., a thermal printhead) and a toggle 316. The platen assembly 312 can include a platen roller 318. The printhead assembly 310 can move between a disengaged position, in which the printhead 314 is positioned away from the platen roller 318 such that the printhead 314 is not positioned to print on media 330, and an engaged position shown in FIGS. 3 and 4, in which the printhead 314 is adjacent to and forms a nip with the platen roller 318 and the printhead 314 is positioned to print on media. After the printhead 314 prints on the media (e.g., via the ribbon or direct thermal), e.g., along a print line 402 (FIG. 4), the media can be dispensed from the media processing device 100 via the media exit 116 and cut by a cutting assembly 340. The frame 302 supports the media spindle 304, the ribbon supply spindle 306, the ribbon take-up spindle 308, the printhead assembly 310, the platen roller 318, and/or the cutting assembly 340, as well as the electronics and drive components (e.g., sensor 404, sensor 406, a logic circuit 502, memory 504, a motor 506, a drive train 508, input/output devices 510, and/or communications interface 512) behind the frame 302 can be operatively coupled to the media spindle 304, the ribbon supply spindle 306, the ribbon take-up spindle 308, the printhead of the printhead assembly 310, and/or the platen roller 318 to control the media spindle 304, the ribbon supply spindle 306, the ribbon take-up spindle 308, the printhead assembly 310, and/or the platen roller 318 (e.g., to rotate the ribbon supply spindle 306, the ribbon take-up spindle 308, and/or the platen roller 318).

As shown in FIG. 4, a sensor 404 can be disposed proximate to the media exit 116 and a sensor 406 disposed proximate the platen roller 318. The sensor 404 can sense the presence or absence of media 330, e.g., at or proximate to the media exit 116 and the sensor 406 can sense a surface 418 of the platen roller 318 and/or the presence or absence of the media 330 on the surface 418 of the platen roller 318. In one example, the sensor 404 can be disposed at an output of the cutting assembly 340 or between the cutting blade 420 of the cutting assembly 340 and the media exit 116 of the media processing device 100. In one example, the sensors 404 and 406 can be optical sensors, where the sensor 404 can be a transmissive optical sensor having an optical receiver 404A opposingly spaced from an optical emitter 404B. In one example, the sensor 404 can be positioned a distance 422 away from the print line 402 (e.g., measure along the feed path 332). The distance 422 can be equal to or less than a circumference of the platen roller 318 such that, for example, a leading edge of the media 330 can travel from the print line 402 to the sensor 404 (e.g., to be sensed by the sensor) based on one revolution of the platen roller 318 or less than one revolution of the platen roller 318. When light emitted by the optical emitter is received by the optical receiver, the output of the sensor 404 can correspond to an absence of the media 330 and when light emitted by the optical emitter is not received by the optical receiver (e.g., the light is blocked/interrupted), the output of the sensor can correspond to the presence of the media between the optical emitter and optical receiver. While the sensor 404 is illustrated as a transmissive sensor, the sensor 404 can be a reflective optical sensor or other suitable type of sensor that can sense the presence or absence of media. In one example, multiple sensors 404 can be disposed proximate to the media exit to detect the presence or absence of the media 330 and/or the sensor 404 can be a sensor array having multiple emitters and receivers.

In one example, the sensor 406 can be a reflective optical sensor, where the optical emitter and receiver can be disposed adjacent to each other. The reflection of the light off of different objects (e.g., the platen roller 318 or the media 330) can have different reflectance causing the output of the sensor 406 to be different. The sensor 406 can be aimed at the platen roller 318 and can be used to detect when the media has wrapped around the platen. In some embodiments, the sensor 406 can be used to detect a type of platen roller 318 installed in the media processing device 100 and/or a degradation of the platen roller. As an example, the different types of platen rollers can be different colors and the output of the sensor 406 can be different based on the color of the platen. As another example, degradation of the platen roller 318 can cause the reflectance of the platen roller 318 to change and the output of the sensor 406 can be different based on the degradation. Degradation of the platen roller 318 can include wear of the platen roller 318 over time and use, a buildup on the platen roller 318, e.g., of adhesive, and/or other aspects that may cause the platen roller 318 to degrade. While the sensor 406 is illustrated as a reflective optical sensor, other suitable type of sensors that can sense the platen roller 318 and presence or absence of media on the platen roller can be embodied by the sensor 406. As an example, the sensor 406 can be an imager (e.g., a CMOS imager or CCD imager) configured to image the platen roller 318 and the images can be used to detect a type of the platen roller, a degradation of the platen roller, and/or whether the media is wrapping around the platen roller 318. In one example, multiple sensors 406 can be positioned and orientated to sense a surface of the platen roller 318 and/or the sensor 406 can be a sensor array having multiple emitters and receivers. In one example, the sensor 406 can be disposed at or near a midpoint of an outer core of the platen roller 318 measured axially along a length of the outer core (e.g., the outer core can provide the surface of the platen roller that is configured engage the media). The sensor 406 can be positioned and oriented to sense the surface 418 of the platen roller 318 at a location relative to the platen roller 318 where the surface 418 does not engage the media 330. The sensor 406 can be offset from the print line 402 circumferentially about the platen roller 318 by an angle 410. In one example, the angle 410 can be forty-five degrees, ninety degrees, or one hundred thirty-five degrees. In one example, the angle 410 can be greater than 0 and less than or equal to ninety degrees. In one example, the angle 410 can be between forty-five degrees and one hundred thirty-five degrees, between forty-five degrees and one hundred eighty degrees, or between ninety degrees and two-hundred seventy degrees.

A media scraper 408 can be disposed downstream of the print line 402 (along the feed path 332), the platen roller 318, and the print head 314, and upstream of the media exit 116 and cutting assembly 340 (along the feed path 332), e.g., between the media exit 116 and the print line 402, the platen roller 318, and/or the print head 314 and/or between the cutting blade 420 of the cutting assembly 340 and the print line 402, the platen roller 318, and the print head 314. The media scraper 408 can be configured to aid in guiding the media off of the platen roller 318, through the cutting assembly 340, and to the media exit 116. The sensor 406 can be disposed under the media scraper 408, positioned and oriented to sense a surface of the platen roller 318.

With reference to FIGS. 5-7, the logic circuit 502 of the media processing device 100 can be operatively coupled to the printhead 314, the sensor 404, the sensor 406, the memory 504, the motor 506, the input/output (I/O) devices 510, the communication interface 512, and the encoder/reader 514. In one example, the logic circuit 502 can be configured to execute code stored in the memory 504 to perform operations and functions of the media processing device 100, e.g., by communicating with and/or controlling one or more components of the media processing device 100. The logic circuit 502 can execute the code stored memory 504 to determine a type of the platen roller 318 that is installed in the media processing device 100 and can configure an operation and/or parameters of the media processing device 100 based on the type of platen roller 318. The logic circuit 502 can execute the code stored memory 504 to determine a degradation of the platen roller 318 and can output an indication to a user or another device via one or more of the I/O device 510 and/or the communication interface 512. The logic circuit 502 can execute the code stored memory 504 to implement a printing operation or function that controls the motor 506 to rotate the platen roller 318 to feed the media 330 past print line 402 at which the printhead 314 prints on the media 330 (either directly or by transferring an ink from a ribbon to the media) and can receive output signals from the sensors 404 and 406 that can be used by the logic circuit 502 to determine whether the media processing device 100 is operating as intended (e.g., to print/encode media and output the media 330 via the media exit 116). For embodiments in which the media spindle 304 is driven, the logic circuit can drive the motor 522 to rotate the media spindle 304. The motors 506 and/or 522 can be a stepper motor and the logic circuit 502 track a number steps the motors 506 and/or 522 have rotated to determine a number of degrees that platen roller 318 and/or the media spindle 304, respectively, have rotated (e.g., accounting for gear ratios of the drive trains 508 and/or 524). Alternatively, or in addition, a rotary encoder can be used to determine a number of degrees the shafts of the motors 506 and/or 522 have rotated and/or a number of degrees that the platen roller 318 and/or media spindle 304 have rotated.

In an example operation with reference to FIGS. 3-7, before a printing operation may begin, the print media (linerless media 330) is loaded into the media processing device 100. The supply of linerless media 330 (e.g., a media roll) can be supported by the media spindle 304 and routed along the feed path 332 from the media supply and past the platen roller 318 and printhead 314. One or more media guides 334 can support and guide the linerless media 330 along the feed path 332. The printhead assembly 310 can be in the disengaged position such that the printhead 314 is spaced away from the platen roller 318 and a gap is created between the printhead 314 and the platen roller 318 which can allow a user to more easily feed the media 330 through the gap and to the media exit 116.

In addition to loading the media 330, for embodiments of the media processing device 100 that are configured to transfer an image from a ribbon to the media 330, an ink ribbon can be inserted between the printhead 314 and the platen roller 318. The ink ribbon can include a supply spool and a take-up spool, each disposed on a respective spindle. The ink ribbon is fed along an ink ribbon path extending from the supply spool, around the printhead assembly 310, past the printhead 314.

After the linerless media 330 is loaded into the internal cavity 200 and fed through the media feed path 332 past a print mechanism formed the printhead 314 of printhead assembly 310 and the platen roller 318 of the platen assembly 312 (and in some embodiments, after the ink ribbon is installed), the printhead assembly 310 can be moved from the disengaged position to the engaged position via the toggle 316 such that the printhead 314 and the platen roller 318 form a nip and define the print line 402. The platen roller 318 can be driven by the motor 506 via the drive train 508 to rotate the platen roller 318 about an axis of rotation in a first direction (e.g., counterclockwise in the orientation shown in FIG. 4) to pull the linerless media through the feed path 332 and can be driven by the motor 506 via the drive train 508 to rotate the platen roller 318 about the axis of rotation in a second direction (e.g., counterclockwise in the orientation shown in FIG. 4) to retract the media 330. The continuous web of linerless media 330 can be coated on one surface 336 with a pressure sensitive adhesive (or other adhesive) and can include a printable surface on the opposite side 338. For thermal transfer printing, the printable surface of the linerless media is configured to receive a pigment (e.g., resin, wax-resin, etc.) that is transferred from an ink ribbon installed on the ribbon supply and take-up spindles 306 and 308, respectively. For direct thermal printing, a thermal printhead of the media processing device 100 directly contacts the printable surface triggering a chemical or physical change in a thermally sensitive dye covering at least a portion of the printable surface of the media.

During a printing operation, the linerless media 330 is routed along the feed path 332 from the media supply to the print line 402 located beneath the printhead 314. The linerless media 330 is pulled through the feed path 332 by the driven platen roller 318 rotating in a first direction (counterclockwise in the orientation illustrated in FIG. 4 or clockwise in the orientation illustrated in FIGS. 5-7). Initially and/or after a printed portion of media is output from the media processing device (e.g., a printed portion is cut by the cutting assembly and presented at the media exit 116), the leading or terminal end of the media can be registered relative to the print line to position the media for printing. In some embodiments, the supply of the linerless media 330 can be moderately biased/tensioned to oppose the driving force produced by the platen roller 318 to maintain tension in the web of linerless media 330 along the feed path 332 as the media 330 is pulled through the media processing device 100 by the platen roller 318. The platen roller 318 is in contact with the adhesive surface 336 of the linerless media 330 as it rotates to pull the linerless media 330 through the feed path 332. Once printed, the printed portion of the linerless media 330 is advanced outwardly from the media processing device 100 through a media exit 116 by the platen roller 318 where it can be cut and/or torn to separate the printed media from the media supply e.g., the cutting blade 420 of the cutting assembly 340 can be disposed proximate to the media outlet 116 (e.g., between the printing mechanism and the media outlet) to cut the media as it exits the media outlet 116, after which the platen roller 318 can be driven to retract the media and register the new leading or terminal end of the media 330 relative to the print line for the next print job.

In some instances, media handling errors may occur. As an example, as the linerless media 330 is fed through the feed path 332 and/or in response to certain conditions (environmental and/or physical), the adhesive of the linerless media 330 can cause the linerless media 330 to adhere to the platen roller 318 (e.g., to the surface 418 of the platen roller) as the platen roller 318 rotates in response to being driven by the motor 506 (e.g., via the drive train 508). As a result, the linerless media 330 can wrap around the platen roller 318 and/or jam at the platen roller 318. As another example, the linerless media can jam at the print line 402, between the print line 402 and the media exit 116, or between the print line 402 and the cutting blade 420 of the cutting assembly 340 without wrapping around the platen roller 318. The output of the sensors 404 and 406 can be used by the logic circuit 502 to determine whether a media handling error has occurred, distinguish between different types of media handling errors, and/or can be configured to perform one or more exception handling operations. In one example, the sensor 404 can be used to detect the leading edge of the media before the platen roller 318 completes revolution. If there is a media handling error in the form a media wrap around the platen, the logic circuit 502 can stop the media processing device based on the output of the sensor 406 and can direct a user or other device with instructions to clear the media transport error via one or more of the I/O device 510 and/or the communications interface 512. If there is a media handling error in the form of a media jam in the feed path from the print line 402 to the blade 420 of the cutting assembly 340, the logic circuit 502 is expecting the sensor 404 would detect the leading edge of the media 330 within a specified number of steps of the motor 506 (or a specified number of degrees of rotation of the motor 502 or the platen roller 318). If the sensor 404 does not sense the leading edge of the media 330 with the specified number of steps (or degrees or rotation), the logic circuit would determine that a media jam has occurred and would output instructions to the user or another device to clear the media transport error via one or more of the I/O devices 510 and/or the communications interface 512. The logic circuit 502 can stop the media processing device based on the determination that a media jam has occurred.

FIG. 5 illustrates an operation of an embodiment of the media processing device 100 in which no media handling error is present. While the embodiments of the media processing device 100 is illustrate in a thermal transfer printing configuration that include an ink ribbon 518 and supply and take-up spindles 306 and 308, embodiments of the media processing device 100 can be configured for direct thermal printing that is devoid of the ink ribbon 518 and/or the supply and take-up spindles 306 and 308. As shown in FIG. 5, the logic circuit 502 can execute code stored in the memory 504 to drive the motor to rotate the platen roller 318 in a first direction (clockwise in the orientation illustrated in FIG. 5), e.g., via the drive train 508 to feed the media 330 past a radiofrequency (RF) encoder/reader 520 and/or the printhead 314. For embodiments of the media 330 that include RF tags, the RF encoder/reader 520 can be configured to encode and/or read an RF tags of the media 330. The logic circuit 502 continues to drive the media towards the media exit 116 past the cutting assembly, which can be operative to cut the media 330 to a specified length. The media can be advanced so that at least a leading edge 516 of the media 330 is at the media exit 116, where the cut portion of the media 330 can be removed. In the present example, the sensor 404 can detect the presence of the media 330 at or near the media exit 116, while the sensor 406 does not detect the media on the platen roller 318. The outputs of the sensors 404 and 406 can be received by the logic circuit 502, which can determine, based on the outputs from the sensors 404 and 406, that the media processing device is operating properly. In one example, the logic circuit 502 can execute the code stored in the memory to pause operation of the media processing device 100 until the media is removed from the media exit and the sensor 404 senses the absence of the media 330. In one example, the logic circuit 502 can output an indication or alert, via, one or more of the I/O devices 510 and/or the communications interface 512 to notify a user and/or another device that there is media 330 at the media exit that should be removed. After the cut portion of the media is removed the logic circuit 502 can resume operations to encode and/or print on the media 330.

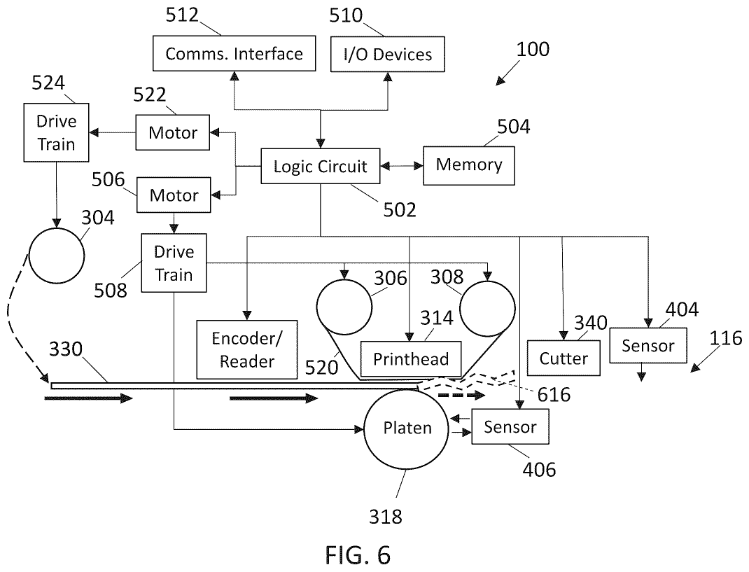

FIG. 6 illustrates an operation of an embodiment of the media processing device 100 in which a media handling error in the form a media jam (or accordion jam) is present. While the embodiments of the media processing device 100 is illustrated in a thermal transfer printing configuration that include an ink ribbon 518 and supply and take-up spindles 306 and 308, embodiments of the media processing device 100 can be configured for direct thermal printing that is devoid of the ink ribbon 518 and/or the supply and take-up spindles 306 and 308. As shown in FIG. 6, the logic circuit 502 can execute code stored in the memory 504 to drive the motor to rotate the platen roller 318 in a first direction (clockwise in the orientation illustrated in FIG. 6), e.g., via the drive train 508 to feed the media 330 past a radiofrequency (RF) encoder/reader 520 and/or the printhead 314. For embodiments of the media 330 that include RF tags, the RF encoder/reader 520 can be configured to encode and/or read an RF tags of the media 330. The logic circuit 502 continues to drive the media towards the media exit 116. However, the media can jam at the print line 402, between the print line 402 and the media exit 116, or between the print line 402 and the cutting blade 420 of the cutting assembly 340 such that, for example, as the media 330 is fed along the feed path, a leading edge 616 of the media 330 cannot continue to proceed along the feed path, which can cause the media to buckle, bend, and/or crease. The output of the sensors 404 and 406 can be used by the logic circuit 502 to determine whether a media handling error in the form of a media jam has occurred and can be configured to perform one or more exception handling operations. As an example, the logic circuit can receive outputs from the sensors 404 and 406. Based on the encoding and/or printing operation being performed by the media processing device 100, the logic circuit 502 can expect to receive an output from the sensor 404 that indicates that media 330 is present at or near the media exit 116. In response to the logic circuit 502 determining that the output of the sensor 404 indicates that the media 330 is absent at or near the media exit 116, the logic circuit 502 can determine that a media handling error has occurred. The logic circuit 502 can determine, from the output of the sensor 406, that the media has not wrapped around the platen roller 318. Based on the absence of the media 330 at or near the media exit 116 (as determined via the output of the sensor 404) and the absence of media wrapped around the platen roller 318 (as determined via the output of the sensor 406), the logic circuit 502 executing code stored in the memory 504, can determine that a media jam has occurred. In response to determining that a media jam has occurred, the logic circuit 502 can implement a first exception handling operation. The first exception handling operation can include outputting an indication or alert via one or more of the I/O devices 510 and/or the communications interface 512 to notify a user and/or another device that there is media jam, provide instructions to the user and/or another device for remediating the media jam, cease driving the platen roller 318, driving the motor to reverse the rotation of the platen roller 318 (e.g., so that the platen roller 318 rotates in a second/counterclockwise direction in the orientation illustrated in FIG. 6), disengage and/or ceasing an operation of the cutting assembly 340, disengage and/or ceasing operation of the printhead 314, and/or cease driving the supply and take-up rollers 306 and 308.

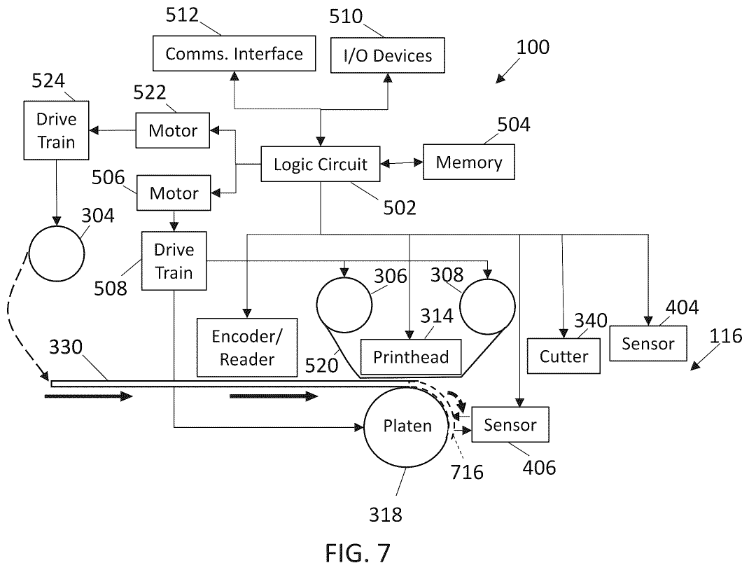

FIG. 7 illustrates an operation of an embodiment of the media processing device 100 in which a media handling error in the form a media wrap is present. While the embodiments of the media processing device 100 is illustrate in a thermal transfer printing configuration that include an ink ribbon 518 and supply and take-up spindles 306 and 308, embodiments of the media processing device 100 can be configured for direct thermal printing that is devoid of the ink ribbon 518 and/or the supply and take-up spindles 306 and 308. As shown in FIG. 7, the logic circuit 502 can execute code stored in the memory 504 to drive the motor to rotate the platen roller 318 in a first direction (clockwise in the orientation illustrated in FIG. 7), e.g., via the drive train 508 to feed the media 330 past a radiofrequency (RF) encoder/reader 520 and/or the printhead 314. For embodiments of the media 330 that include RF tags, the RF encoder/reader 520 can be configured to encode and/or read an RF tags of the media 330. The logic circuit 502 continues to drive the media 330 via the platen roller 318. However, the media 330 can begin to wrap around the platen roller 318 such that, for example, as the media 330 is fed along the feed path, a leading edge 716 of the media 330 deviates from the feed path and follows along a circumference of the platen roller 318. For example, the adhesive of the media can stick to the platen roller 318 such that the media 330 adheres to the platen roller 330, which causes the media 330 to be wound about the platen roller 318 as the platen roller rotates. The output of the sensors 404 and 406 can be used by the logic circuit 502 to determine whether a media handling error in the form of a media wrap has occurred and can be configured to perform one or more exception handling operations. As an example, the logic circuit 502 can receive outputs from the sensors 404 and 406. Based on an output of the sensor 406, the logic circuit 502 can determine that the media has started to wrap around the platen roller 318. Alternatively, or in addition, based on the encoding and/or printing operation being performed by the media processing device 100, the logic circuit 502 can expect to receive an output from the sensor 404 that indicates that media 330 is present at or near the media exit 116 (e.g., based on a number steps or degrees a drive shaft of the motor 506 has rotated or a number of degrees the platen roller 318 has rotated). In response to the logic circuit 502 determining that the output of the sensor 404 indicates that the media 330 is absent at or near the media exit 116, the logic circuit 502 can determine that a media handling error has occurred. The logic circuit 502 can determine, from the output of the sensor 406, that the media has started to wrapped around the platen roller 318. Based on the absence of the media 330 at or near the media exit 116 (as determined via the output of the sensor 404) and the presence of media wrapped around the platen roller 318 (as determined via the output of the sensor 406), the logic circuit 502 executing code stored in the memory 504, can determine that a media wrap has occurred. In response to determining that a media wrap has occurred, the logic circuit 502 can implement a second exception handling operation. The second exception handling operation can include outputting an indication via one or more of the I/O devices 510 and/or the communications interface 512 to notify a user and/or another device that there is a media wrap, provide instructions to the user and/or another device for remediating the media wrap, cease driving the platen roller 318, driving the motor to reverse the rotation of the platen roller 318 (e.g., so that the platen roller 318 rotates in a second/counterclockwise direction in the orientation illustrated in FIG. 7), disengage and/or ceasing an operation of the cutting assembly 340, disengage and/or ceasing operation of the printhead 314, cease driving the supply and take-up rollers 306 and 308, and/or drive a secondary media drive mechanism (e.g. a second driven roller, such as media supply spindle) to attempt to recover from the media wrap using the secondary media drive mechanism to peel the media off of the platen roller 318. In one example, the first and second exception handling operations are the same. In one example, the first and second exception handling operations are different.

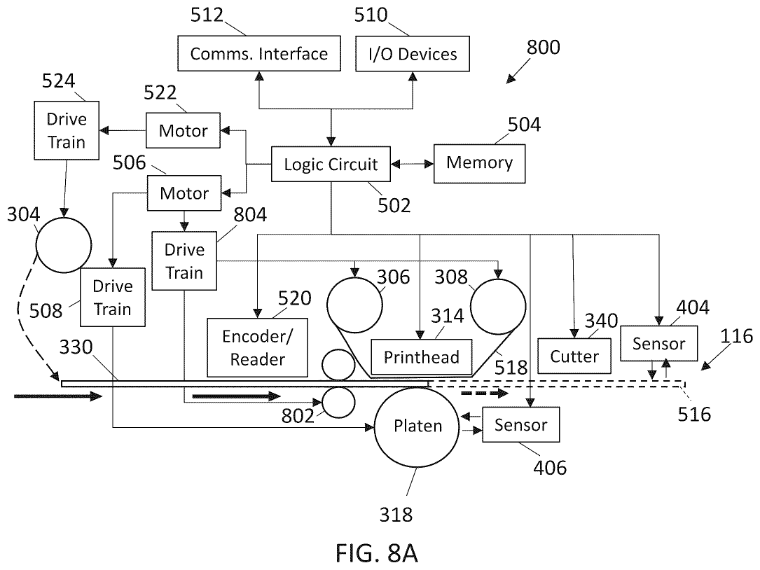

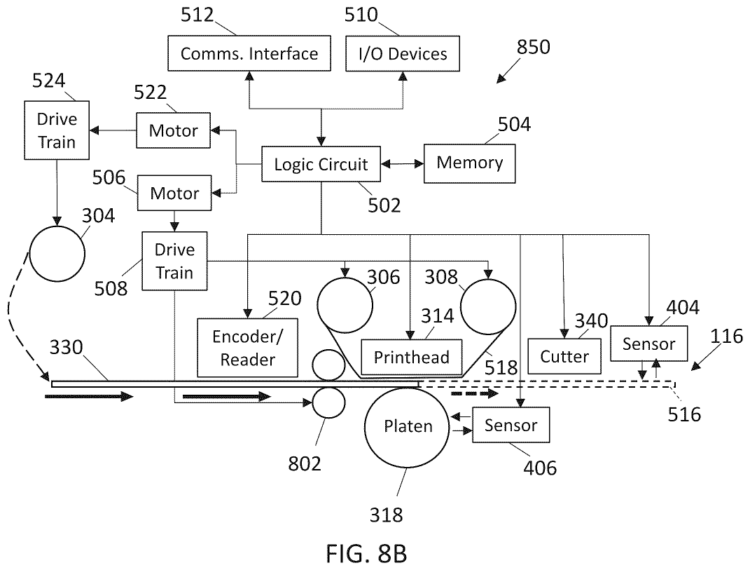

FIG. 8A is an example is a block diagram illustrating another example media processing device 800 in accordance with embodiments of the present disclosure. The components and operations of the media processing device 800 are the same as the components of the media processing device except as differences described herein. For the sake of brevity, common elements or elements with the same reference numbers may not be described or may not be described in detail with reference to the media processing device 800. Therefore, the following description focuses on the differences between media processing devices 800 and 100. As shown in FIG. 8, a drive train 804 can be operatively coupled to a traction roller 802 which can be driven by the motor 506 to aid in advancing the media 330 along the media path 332. When a media handling error (e.g., a media jam or media wrap) is detected based on the output of the sensor 404 and/or sensor 406, the media processing device 800 can operate in a similar manner as the media processing device 100 except that the logic circuit may cease driving the platen roller 318 and reverse the drive direction of the traction roller 802 or may reverse the drive direction of the platen roller 318 and traction roller 802.

FIG. 8B is an example is a block diagram illustrating another example media processing device 850 in accordance with embodiments of the present disclosure. The components and operations of the media processing device 850 are the same as the components of the media processing device except as differences described herein. For the sake of brevity, common elements or elements with the same reference numbers may not be described or may not be described in detail with reference to the media processing device 850. Therefore, the following description focuses on the differences between media processing devices 850 and 100. As shown in FIG. 8, the platen roller 318 is not driven and my rotate freely as the media 330 is advanced along the feed path 332. Instead, the drive train 508 can be operatively coupled to a traction roller 802 which can be driven by the motor 506 to advance the media 330 along the media path. When a media handling error (e.g., a media jam or media wrap) is detected based on the output of the sensor 404 and/or sensor 406, the media processing device 850 can operate in a similar manner as the media processing device 100 except that the logic circuit may cease driving the traction roller 802 or may reverse the drive direction of the traction roller 802.

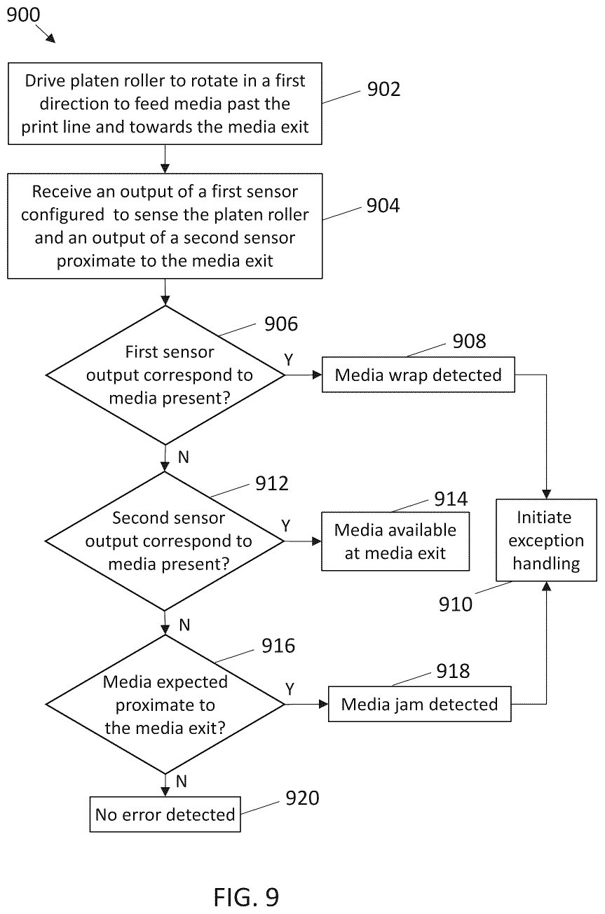

FIG. 9 is an example process 900 that can be implemented by an embodiment of the media processing device 100 in accordance with the present disclosure. At operation 902, a platen roller (e.g., the platen roller 318) is driven (e.g., by the motor 506) to rotate in a first direction to feed media past a print line (e.g., the print line 402) and towards the media exit (e.g., the media exit 116). At operation 904, outputs of a first sensor (e.g., the sensor 406) configured to sense the platen roller and a second sensor (e.g., 404) proximate to the media exit are received by a logic circuit (e.g., the logic circuit 502). At operation 906, the logic circuit executing code stored by memory (e.g., the memory 504) determines whether the output of the first sensor corresponds to a signal that indicates that media is present. If so, at operation 908, the logic circuit determines that a media handling error in the form of media wrapping around the platen roller 318 has occurred, and at operation 910, the logic circuit performs an exception handling operation. If the output of the first sensor corresponds to an absence of media, at operation 912, the logic circuit executes code stored in memory to determine whether the output of the second sensor indicates that media is present. If so, the logic circuit determines that media is available at the media exit. In one example, the logic circuit can wait for the media to be removed from the media exit before performing another encoding and/or printing operation. If the output of the second sensor indicates that media is absent, the logic circuit determines with media was expected to be proximate to the media exit. If not, at operation 920, no error is detected. If media is expected to be proximate to the media exit and the outputs of the first and second sensors correspond to an absence of media, at operation 918, the logic circuit executing code stored in the memory determines that a media jam has been detected, and the logic circuit performs an exception handling operation at operation 910.

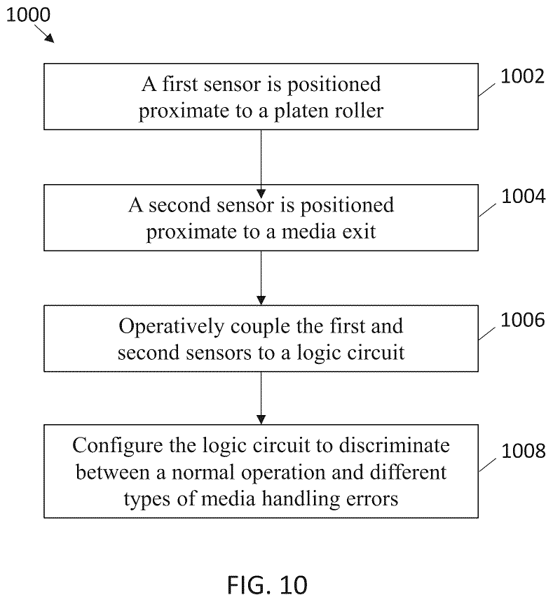

FIG. 10 is a flowchart illustrating an example process 1000 in accordance with embodiments of the present disclosure. At operation 1002, a first sensor (e.g., sensor 406) is positioned proximate to a platen roller (e.g., platen roller 318) of a media processing device (e.g., media processing device 100). The first sensor is offset from a print line (e.g., print line 402) by a nonzero angle (e.g., angle 410) circumferentially relative to a surface (e.g., surface 418) of the platen roller and oriented to sense the surface of the platen roller as the platen roller rotates. The first sensor is configured to provide a first output that is indicative of whether media (e.g., media 330) has adhered to the surface of the platen roller after passing the print line. At operation 1004, a second sensor (e.g., sensor 404) is positioned proximate to a media exit (e.g., media exit 116). The second sensor is configured to provide a second output that is indicative of whether the media is present at the media exit. At operation 1006, the first and second sensors are operatively coupled to a logic circuit (e.g., logic circuit 502). At operation 1008, the logic circuit is configured to execute code stored in memory to discriminate between a normal operation of the media processing device a media jam error, e.g., a first type of media handling error, and a media wrap error, e.g., a second type of media handling error, based on first and second outputs from the first and second sensors.

The above description refers to diagrams of the accompanying drawings. Alternative implementations of the example represented by the diagrams include one or more additional or alternative elements, processes and/or devices. Additionally or alternatively, one or more of the example elements of the diagram may be combined, divided, re-arranged or omitted.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A media processing device, comprising:
a platen roller;
a printhead configured to form a nip with the platen roller;
a media exit;
a first sensor disposed proximate to the platen roller,
a second sensor disposed proximate to the media exit; and
a logic circuit operatively coupled to the first and second sensors, the logic circuit configured to:
discriminate between a normal operation of the media processing device, a media jam error, and a media wrap error based on outputs from the first and second sensors.

2. The media processing device of claim 1, wherein the first sensor is configured to sense a state of the platen roller and the second sensor is configured to sense the presence or absence of media proximate to the media exit.

3. The media processing device of claim 1, further comprising:
a motor operatively coupled to the platen roller,
wherein the logic circuit is configured to cease driving the motor in response to detecting a media jam error or media wrap error.

4. The media processing device of claim 1, further comprising:
a motor operatively coupled to the platen roller,
wherein the logic circuit is configured to drive the motor to rotate the platen roller in a first direction to facilitate a printing process and to drive the motor to rotate the platen roller in a second direction in response to detecting a media jam error or media wrap error.

5. The media processing device of claim 4, wherein the logic circuit drive the motor to rotate the platen roller in the second direction.

6. The media processing device of claim 1, further comprising:
an output device operatively coupled to the logic circuit,
the logic circuit is configured to output an indication via the output device in response to the logic circuit determining that the media jam error or the media wrap error has occurred.

7. The media processing device of claim 4, wherein the logic circuit is configured to output a first indication when the logic circuit determines that the media jam error has occurred and to output a second message when the logic circuit determines that the media wrap error has occurred.

8. The media processing device of claim 1, wherein the printhead defines a print line that is radially disposed relative to the platen roller in first plane and the first sensor radially disposed relative to the platen roller in a second plane, the second plane having a nonzero angle relative to a first plane.

9. The media processing device of claim 8, wherein the non-zero angle is forty-five degrees, ninety degrees of one hundred eighty degrees.

10. (canceled)

11. (canceled)

12. The media processing device of claim 8, wherein the nonzero angle is (i) greater than zero and less than ninety degrees or (ii) greater than to forty-five degrees and less than one-hundred thirty-five degrees.

13. (canceled)

14. The media processing device of claim 1, wherein the first sensor is offset from a print line by a nonzero angle circumferentially relative to a surface of the platen roller and oriented to sense a surface of the platen roller as the platen roller rotates, the first sensor is configured to provide a first output that is indicative of whether media has adhered to the surface of the platen roller after passing the print line.

15. (canceled)

16. The media processing device of claim 1, further comprising:
a media scraper disposed between the platen roller and the media exit, the media scraper configured to guide media off of the platen roller and towards the media exit,
the first sensor being disposed under the media scraper.

17. The media processing device of claim 1, further comprising:
a cutting assembly disposed between the platen roller and the media exit,
the second sensor being disposed between a cutting blade of the cutting assembly and the media exit.

18. The media processing device of claim 1, wherein the logic circuit is configured to determine that the media wrap error has occurred based on an output of the first sensor indicating the presence of media.

19. The media processing device of claim 17, wherein the logic circuit is configured to determine that the media jam error has occurred based on the logic circuit expecting media to be present at the media exit, the output of the first sensor indicates the media is absent, and the output of the second sensor indicates the media is absent.

20. The media processing device of claim 1, further comprising:
at least one of a media supply spindle or a further roller,
a motor operatively coupled to the at least one of the media supply spindle or the further roller,
wherein the logic circuit is configured to drive the motor to rotate the at least one of the media supply spindle or the further roller in a first direction to facilitate a printing process and to drive the motor to rotate the at least one of the media supply spindle or the further roller in a second direction in response to detecting a media jam error or media wrap error.

21. (canceled)

22. A method comprising:
driving a platen roller to advance media along a feed path past a printhead and towards a media exit of a media processing device;
sensing, via a first sensor disposed proximate to the platen roller, whether the media is present or absent;
sensing, via the second sensor disposed proximate to the media exit, whether the media is present or absent; and
discriminating, by a logic circuit, between a normal operation of the media processing device, a media jam error, and a media wrap error based on outputs from the first and second sensors.

23-26. (canceled)

27. The method of claim 22, wherein a print line is radially disposed relative to the platen roller in a first plane and the first sensor is radially disposed relative to the platen roller in a second plane, the second plane having a nonzero angle relative to a first plane.

28-36. (canceled)

37. The method of claim 22, comprising:
determining that the media jam error has occurred based on expecting media to be present at the media exit, wherein the output of the first sensor indicates the media is absent, and the output of the second sensor indicates the media is absent.

38. A non-transitory computer readable medium storing instructions, wherein execution of the instructions by a logic circuit causes the logic circuit to perform a method comprising:
driving a platen roller to advance media along a feed path past a printhead and towards a media exit of a media processing device;
sensing, via a first sensor disposed proximate to the platen roller, whether the media is present or absent;
sensing, via the second sensor disposed proximate to the media exit, whether the media is present or absent; and
discriminating, by a logic circuit, between a normal operation of the media processing device, a media jam error, and a media wrap error based on outputs from the first and second sensors.
